(19) United States
(12) Patent Application Publication
(10) Pub. No.: US 2016/0010886 A1
(43) Pub. Date: Jan. 14, 2016

(54) Concealed Housing For A Solar Powered Attic Fan

(71) Applicant: Edward James Dukes, Sarasota, FL (US)

(72) Inventor: Edward James Dukes, Sarasota, FL (US)

(73) Assignee: Solar Industries Inc., Sarasota, FL (US)

(21) Appl. No.: 14/327,554

(22) Filed: Jul. 9, 2014

(51) Int. Cl. F24F 7/02; H02J 9/06; H02J 7/00; H02J 7/35

(52) U.S. Cl. CPC F24F 7/025; H02J 7/35; H02J 9/06; H02J 7/007

(57) ABSTRACT

A solar powered attic fan having a solar panel in electrical communication with a fan vent having a housing. The attic fan system operates on a Variable Direct Current (VDC) that is powered by solar power. The housing is adapted to support a motor having fan blades attached thereto. The housing is connected to the underside of a roof vent. A flange is located around the perimeter of the housing. The flange has a surface that receives an attaching element. A fastener can be received by an opening in the flange to secure the housing to the underside of a roof vent. The flange can be a layer extending from the perimeter of the housing to create a seal between the housing and an opening of a roof vent. The flange has a plurality of hinged mounting tabs having an opening adapted to receive a fastener.

### BACKGROUND OF THE INVENTION

1. Field of the Invention

This invention relates, generally, to a housing for a solar powered attic fan.

More particularly, it relates to an attic fan energized by solar power capable of being received by the novel attic fan housing.

2. Background Art

Prior art attic fans are mounted to the exterior of a roof. Exterior mounted fans can be exposed to harsh weather conditions such as rain, sleet, hail, and snow. Debris can become lodged in these fans, rendering them to be inoperable for their intended function. Prolonged periods of sun exposure can cause any resin based fan components to deteriorate. Additionally, metal parts of a fan can corrode when exposed to the elements. Thus, there is a need for an attic fan housing that is configured to be concealed and mounted to the interior wall of an attic.

Currently, fan vent manufacturers require an opening through a roof to receive a fan vent including, but not limited to, a ridge vent, a hood vent, a turbine vent, or a barrel vent. There is a need for a fan vent having an integral housing to create a seal between the fan and the roof opening. This seal is desirable because it prevents including, but not limited to, rain or debris from entering through the vent opening.

The vast majority of commercially available attic fans are powered by a household Alternating Current (AC). AC power can be costly for a user. Therefore, there is a need for an attic fan system that operates by direct connection solar panel or on a battery powered by Direct Current (DC) that is replenished by solar power.

Conventional solar powered attic fans do not use a battery. According to www.outdoorsolarstore.com, “all solar attic fans on the market today are powered by the solar panel directly to the motor.” The solar attic fan “can also use house power as a backup source.” When sufficient sunlight is not available, solar power is not available and there will not be a power supply to cool an attic unless the attic fan draws costly household AC current. There is a need for an attic to be cooled at night with the use of a battery to store a surplus of energy, allowing the fan to run for a period of time at night so the attic is not storing hot air that has been accumulating during the day.

Prior art solar powered attic fan systems are solely focused on ventilating an area. There is a need for a multi-function solar powered attic fan system that is configured to operate as a remote power source for household devices such a backup power supply for a security panel or a cost effective power source for including, but not limited to, landscape lighting (not shown).

However, in view of the prior art considered as a whole at the time the present invention was made, it was not obvious to those of ordinary skill in the pertinent art how the identified needs could be fulfilled.

### SUMMARY OF THE INVENTION

The long-standing but heretofore unfulfilled need for a solar direct panel VDC system having a housing configured to support a fan motor and blades with a perimeter wall flange and having an attaching element adapted to be connected to a surface of the flange, and having a fastener to be received by a flange opening which also includes improvements that overcome the limitations of prior art attic fan systems is now met by a new, useful, and non-obvious invention.

In a preferred embodiment, the solar powered attic fan has at least one solar panel in electrical communication with at least one fan vent having a novel housing. This attic fan system operates on a Variable Direct Current (VDC) that is powered by solar power. The novel housing is adapted to support at least one motor having fan blades attached thereto. The housing is connected to the underside of a roof vent. At least one flange is located around the perimeter of the housing. The flange has a surface that receives an attaching element including, but not limited to, adhesive, tape, double sided tape, or a hook and loop attachment. Additionally, at least one fastener including, but not limited to, a nail or a screw can be received by at least one opening in the flange to secure the housing to the underside of a roof vent. The flange can be a layer extending from the perimeter of the housing to create a seal between the housing and an opening of including, but not limited to, a barrel vent, a hood vent, or a turbine vent.

The flange can also have a plurality of hinged mounting tabs. The hinged mounting tabs have at least one opening to receive a fastener. The housing is adapted to create a seal between an opening of including, but not limited to, a ridge vent. In a preferred embodiment, double sided tape having one side attached to a portion of the housing flange and another side of the double sided tape is connected to the underside of a roof vent. Additionally, at least one fastener including, but not limited to, a nail or a screw can be received by at least one opening in the flange to secure the housing to the underside of a roof vent.

In another embodiment, the opening in a roof from a fan vent including, but not limited to, a ridge vent or a barrel vent can be sealed with at least two panels and a fan housing having at least one flange extending from a portion of the housing perimeter forming a hinge. It is a preferred embodiment that three flanges are located on both sides of the novel housing. The flanges are adapted to contour to a plurality of roof pitches. At least two panels can be installed from the underside of a roof to seal the elongated openings from the fan vent. The panels are formed from a primary layer being connected to an adjacent secondary layer. After the panels are installed, the fan housing is then inserted through the existing roof vent opening. The housing is secured to the underside of the roof with at least one of an attaching element or a fastener, forming a seal.

The novel attic fan system includes an attic fan adapted to be configured with existing roof vents. A solar panel is mounted in an area where the solar panel is exposed to sunlight including, but not limited to, a roof, a wall, or the ground. The solar panel is connected to a control box with an electrically conductive wire. An electrical current generated by the solar panel is transferred through a conductor to the control box. The control box has a housing containing including, but not limited to, a plug connector, a thermostatically controlled switch, a charging regulator circuit, and a battery. The control box is connected to an electric motorized fan. In a preferred, the housing is located exterior to a room. It is within the scope of this invention for the housing to be mounted to the interior of a room.

In another embodiment, the solar panel can have a conductive wire having an end connected to a solar panel and an opposite end connected to the fan motor.

In another embodiment, the control box has two regulators that are capable of receiving a charge from a conductive wire connected to at least one solar panel. A conductive wire connects at least one regulator to at least one battery. In a preferred embodiment, two regulators are provided. A battery being replenished by solar power is capable of powering a plurality of systems including, but not limited to, a motorized fan, an alarm system, a household device, or landscape lighting. It is a preferred embodiment that the control box is mounted outdoors. However, it is within the scope of this invention for the control box to be mounted inside of a room.

In an alternate embodiment, the solar panel has a novel mounting system including a mounting bracket, rod tubing, and support structures. The mounting bracket has a primary L-bracket, a secondary L-bracket, and a tertiary L-bracket. The primary L-bracket and secondary L-bracket both have a structure receiving side connected to an adjacent securing side adapted to secure the tertiary L-bracket. The structure receiving side is connected to a portion of a structure including, but not limited to, a wall or a fascia. The tertiary L-bracket has a solar panel receiving side connected to an adjacent side that is secured by the primary L-bracket and secondary L-bracket securing side.

The structure receiving sides each have at least one opening to receive a fastener to secure the mounting bracket to a portion of a structure. The securing sides each have at least one opening to receive a fastener to secure the tertiary L-bracket to both the primary L-bracket and secondary L-bracket. The solar panel receiving side has at least one opening to receive a fastener to secure a solar panel.

The solar panel has a primary side located opposite a solar panel secondary side. The primary side is exposed to sunlight. The secondary side is connected to a support structure. The support structure has at least two strips of ridged material including, but not limited to, metal, aluminum, or steel. The support structure has a primary end connected to a portion of the solar panel and a secondary end connected to an opposite side of the solar panel. A rod is connected to the solar panel with including, but not limited to, a U-bracket. The rod is any ridged material including, but not limited to, plastic, metal, aluminum, or steel. The rod is adapted to pivot so that the position of the solar panel can be adjusted by a user.

### BRIEF DESCRIPTION OF THE DRAWINGS

For a fuller understanding of the nature and objects of the invention, reference should be made to the following detailed description, taken in connection with the accompanying drawings, in which:

FIG. 1 is a flow chart of the novel solar panel having a multipurpose control center.

FIG. 2 is a cut-away view of the novel multipurpose control center.

FIG. 3 is a perspective view of the novel solar powered attic fan system with a multipurpose control center.

FIG. 4 is a perspective view of the novel solar panel being directly connected to a plurality of electrical fan motors each having a housing.

FIG. 5 is a perspective view of the novel housing having a flange for a plurality of electrical fans.

FIG. 6 is a perspective view of the novel housing for a ridge vent fan having a plurality of flanges connected thereto and having a set of panels.

FIG. 7 is a perspective view of the novel solar panel mounting bracket.

FIG. 8 is a perspective side view of the novel solar panel and mounting bracket.

FIG. 9 is a perspective bottom view of the novel solar panel and mounting bracket system.

FIG. 10 is a perspective bottom view of the novel solar panel and mounting bracket system.

### DETAILED DESCRIPTION OF THE PREFERRED EMBODIMENT

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

In a preferred embodiment, novel solar panel 2 has multipurpose control center 9 configured to receive a current from solar panel 2 and distribute current to a plurality of devices. The input circuit is connected to solar panel 2 generating an electrical current to regulating circuit 3. It is within the scope of this invention for a plurality of solar panels (not shown) to generate an electrical current to regulating circuit 3. Regulating circuit 3 is connected to battery 4. Battery 4 is connected to thermostatically controlled output circuit 5. Thermostatically controlled output circuit 5 is connected to electric fan 6. Electric fan 6 is attached to an inner attic wall having an opening. Electric fan 6 is in communication with an exterior air source through the opening.

In another embodiment, multipurpose control center 9 is configured to distribute an electrical current to battery 4. Battery 4 supplies a backup power supply to at least one house hold device 10 including, but not limited to, alarm system 7, light emitting unit 1, or memory circuitry 8. Alarm system 7 includes, but is not limited to, a fire detection system, a security system, or a closed circuit television circuit (CCTV). A user can remotely connect household device circuitry 10 to battery 4 to receive power from battery 4. Light emitting unit 1 includes, but is not limited to, household lighting or landscape lighting. Memory circuitry 8 is any item that has memory and that needs a power supply to prevent loss of memory including, but not limited to, a computer or a timer. Additionally, during emergency situations communication devices can be charged from the attic fan system. The attic fan system has battery 4 capable of powering an emergency port (not shown) for chargeable devices.

In another embodiment, multipurpose control center 9 is configured to distribute an electrical current to battery 4. Battery 4 supplies a backup power supply to a plurality of fans (not shown).

In another embodiment, electrically powered fan 6 is connected to housing 27. Housing 27 has an opening great enough in size to receive at least one electrically powered fan 6. Housing 27 has flange 26 located on an outer perimeter of housing 27. Flange 26 is connected to attaching element 29. Attaching element 29 is adapted to connect to a surface of an inner wall. Flange 26 can have an opening 33 to receive a fastener.

In another embodiment, flange 26 has a plurality of hinged mounting tabs 30. Hinged mounting tabs 30 can have opening 33 to receive a fastener (not shown).

In another embodiment, solar panel 2 is supported by mounting bracket 11. Mounting bracket 11 has primary side 15A and 15 B connected to a structure by at least one fastener 25. Mounting bracket 11 has secondary side 17 supporting solar panel 2. Solar panel 2 is pivotally supported by mounting bracket 11.

### Construction of the Novel Concealed Solar Powered Attic Fan

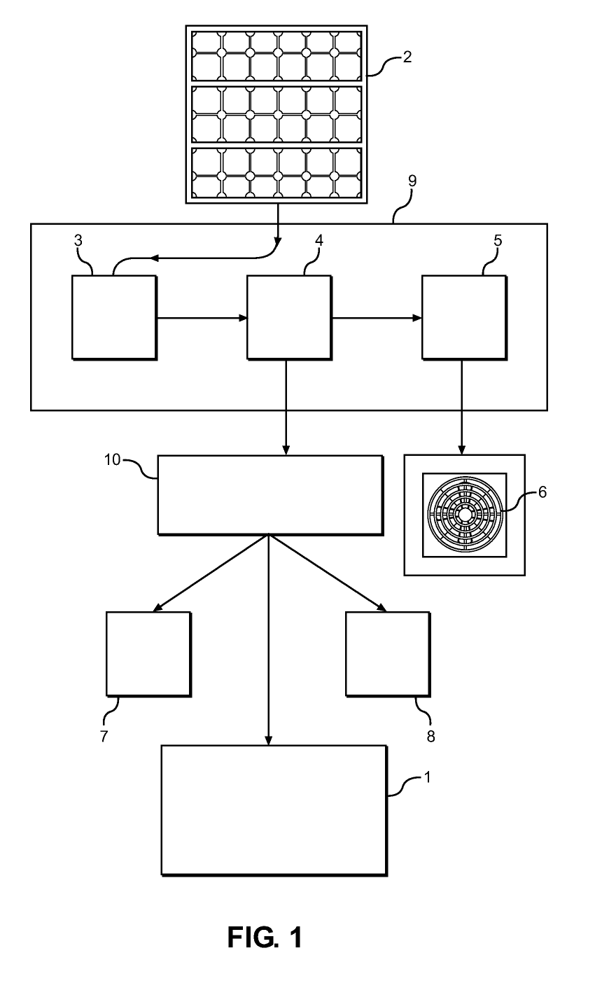

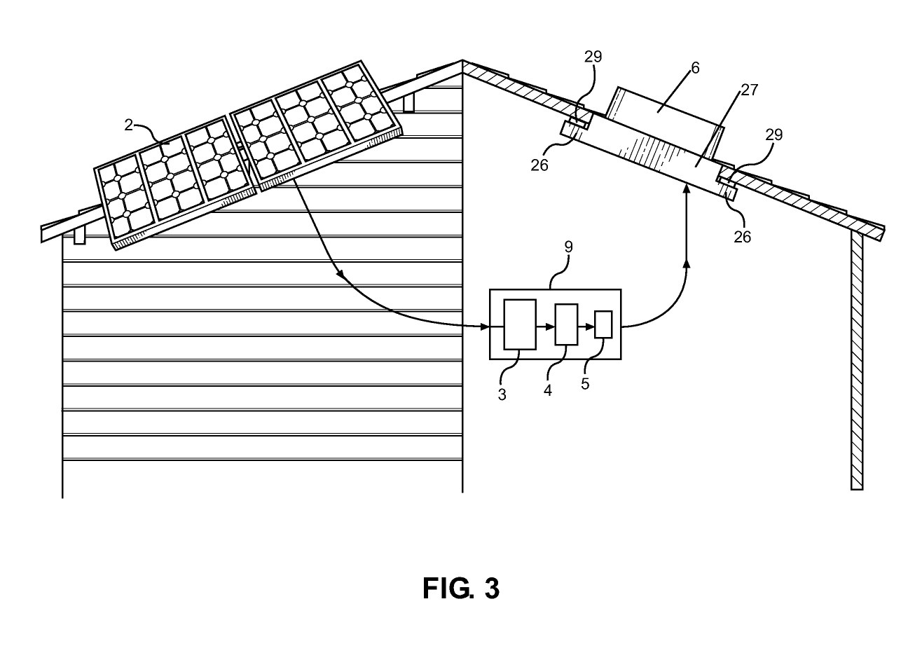

It will now be seen, referring to FIGS. 1 and 3 depict, the novel concealed solar powered attic fan having multipurpose control center 9 has at least one solar panel 2 connected to regulating circuit 3. Regulating circuit 3 is connected to battery 4. Battery 4 is connected to thermostatically controlled output circuit 5. Regulating circuit 3, battery 4, and thermostatically controlled output circuit 5 are located within control center housing 9. Thermostatically controlled output circuit 5 is connected to electrical fan 6. FIG. 1 best illustrates battery 4 supplying a backup power supply to at least one household device 10 including, but not limited to, alarm system 7, at least one light emitting unit 1, and memory circuitry 8.

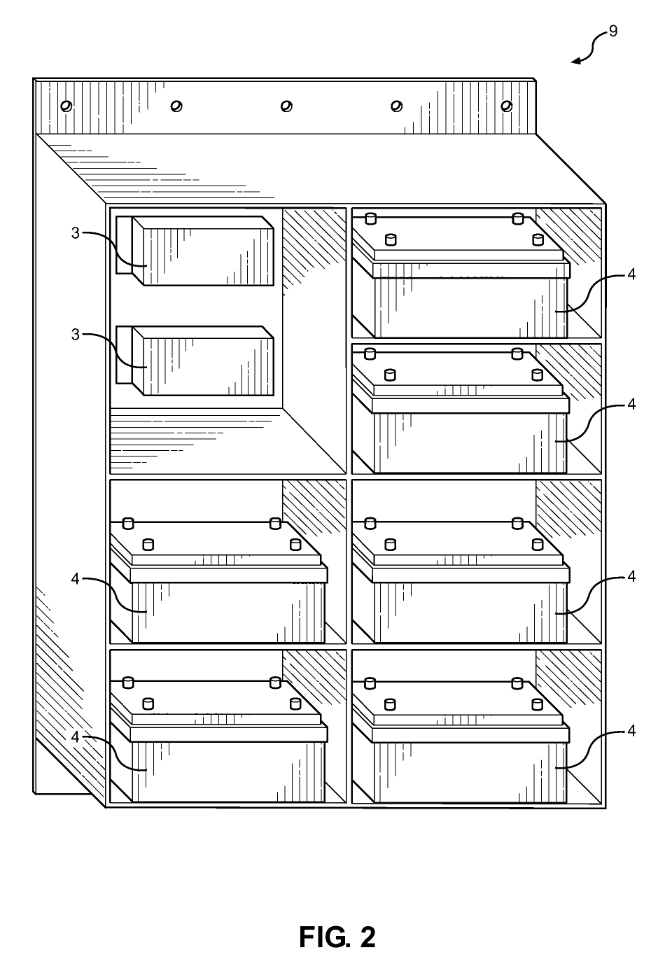

FIG. 2 depicts multipurpose control center 9 having two regulators 3 that are capable of receiving a charge from a conductive wire (not shown) connected to at least one solar panel (not shown). A conductive wire connects at least one regulator 3 to at least one battery 4.

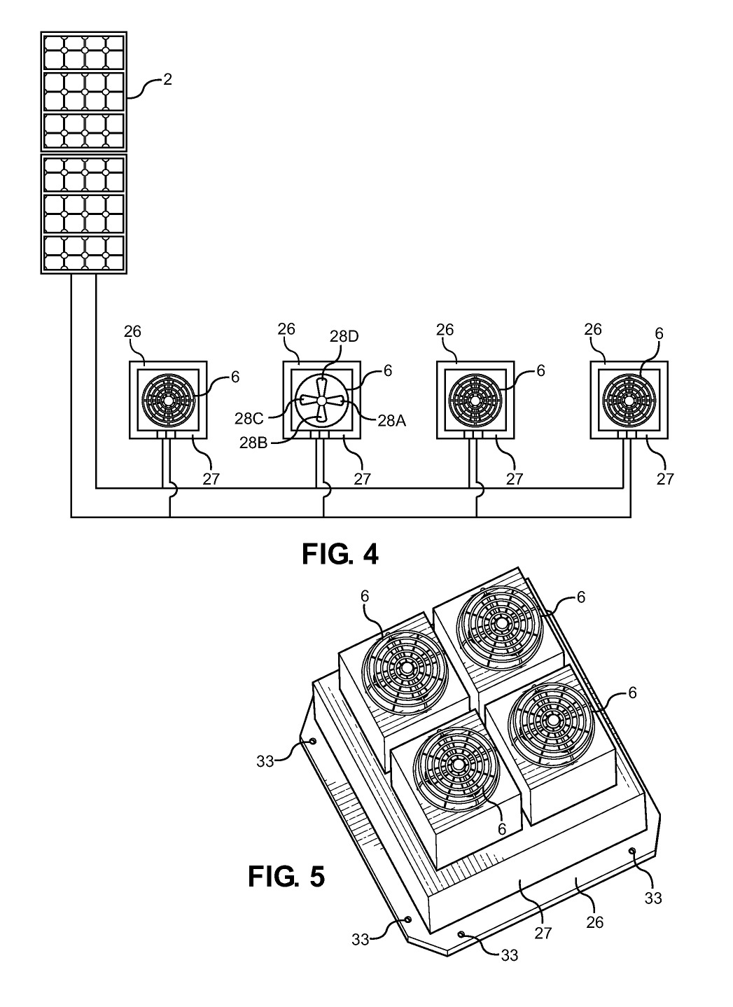

FIG. 4 shows solar panel 2 electrically connected to a plurality of electrical fans 6. Novel fan housing 27 is adapted to support at least one motor (not shown) having fan blades 28A, 28B, 28C, and 28D attached thereto. Fan housing 27 is connected to the underside of a roof vent (FIG. 3). At least one flange 26 is located around the perimeter of fan housing 27. FIG. 3 shows flange 26 having a surface that receives attaching element 29 including, but not limited to, adhesive, tape, double sided tape, or a hook and loop attachment. Attaching element 29 is used to secure fan housing 27 to the underside of a roof vent. Additionally, at least one fastener (not shown) including, but not limited to, a nail or a screw can be received by at least one opening 33 (FIG. 5) in flange 26 to secure fan housing 27 to the underside of a roof vent.

FIG. 5 shows fan housing 27 having plurality of electrical fans 6 located on a surface thereon fan housing 27. Fan housing 27 has flange 26 located around the perimeter of fan housing 27. Flange 26 has at least one opening 33 to receive a fastener (not shown).

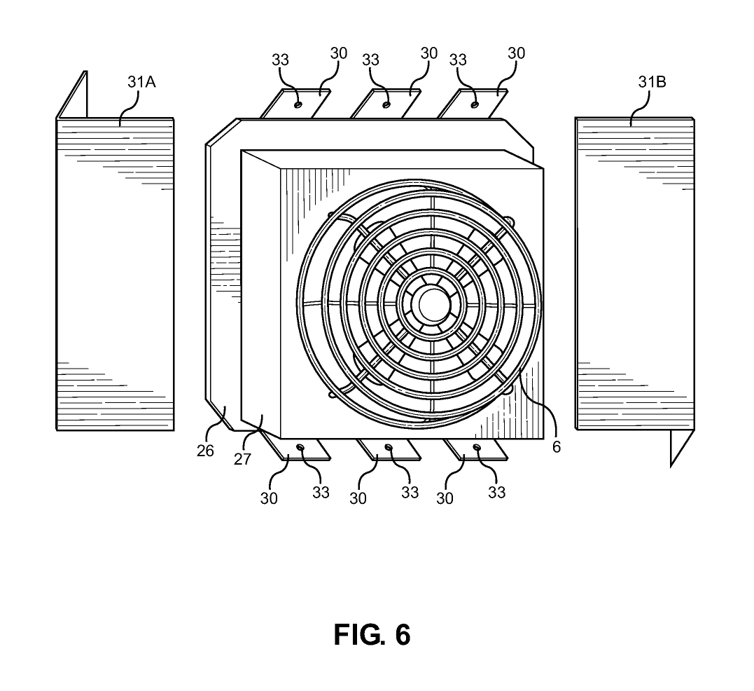

FIG. 6 shows fan housing having electrical fan 6 located on a surface thereon fan housing 27. Fan housing 27 has flange 26 located around the perimeter of fan housing 27. Plurality of hinged mounting tabs 30 extend from a portion of flange 26. Plurality of hinged mounting tabs 30 each have opening 33 configured to receive a fastener (not shown). A set of panels 31A and 31B can be secured to the underside of a roof to seal the elongated openings from a fan vent.

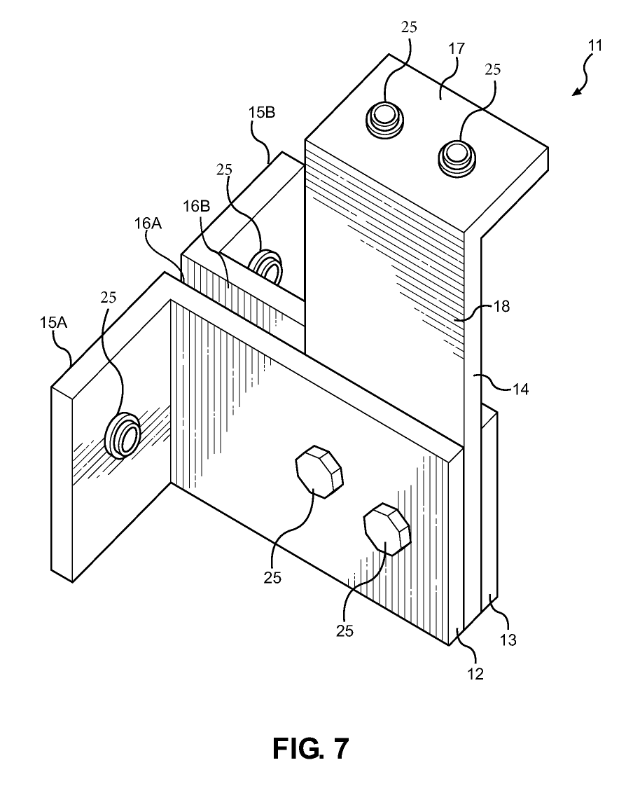

FIG. 7 depicts solar panel mounting bracket 11 having primary L-bracket 12, secondary L-bracket 13, and tertiary L-bracket 14. Primary L-bracket 12 and secondary L-bracket 13 both have structure receiving sides 15A and 15B connected to adjacent securing sides 16A and 16B. Adjacent securing sides 16A and 16B of primary L-bracket 12 and secondary L-bracket 13 are adapted to secure tertiary L-bracket 14. Tertiary L-bracket 14 has solar panel receiving side 17 connected to adjacent side 18 of tertiary L-bracket 14. Adjacent side 18 is secured in place by primary L-bracket 12 and secondary L-bracket 13. Structure receiving sides 15A and 15B each have at least one opening 26 to receive fastener 25 to secure mounting bracket 11 to a portion of a structure. Securing sides 16A and 16B each have at least one opening (not shown) to receive fastener 25 to secure tertiary L-bracket 14 to both primary L-bracket 12 and secondary L-bracket 13. Solar panel receiving side 17 has at least one opening 26 to receive a fastener (not shown) to secure a solar panel (not shown).

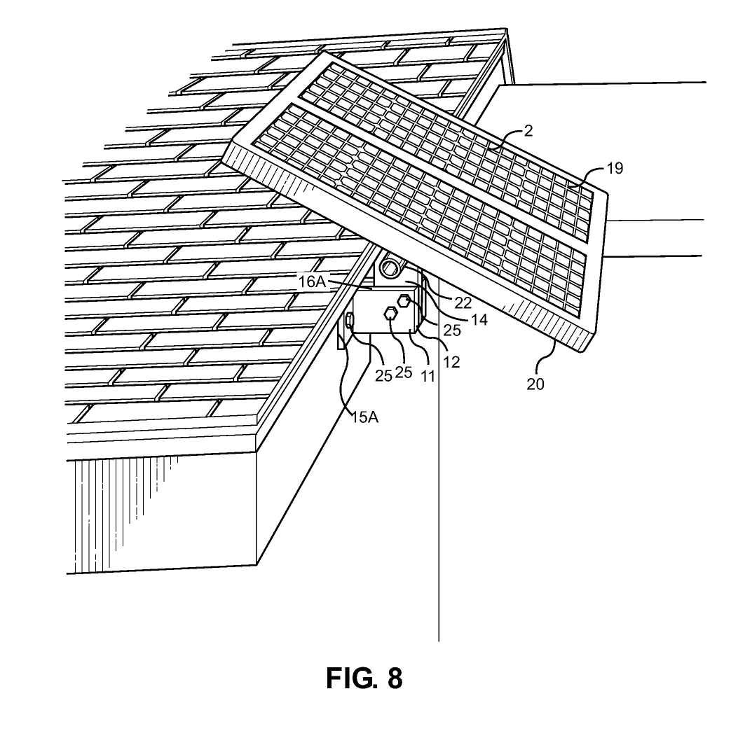

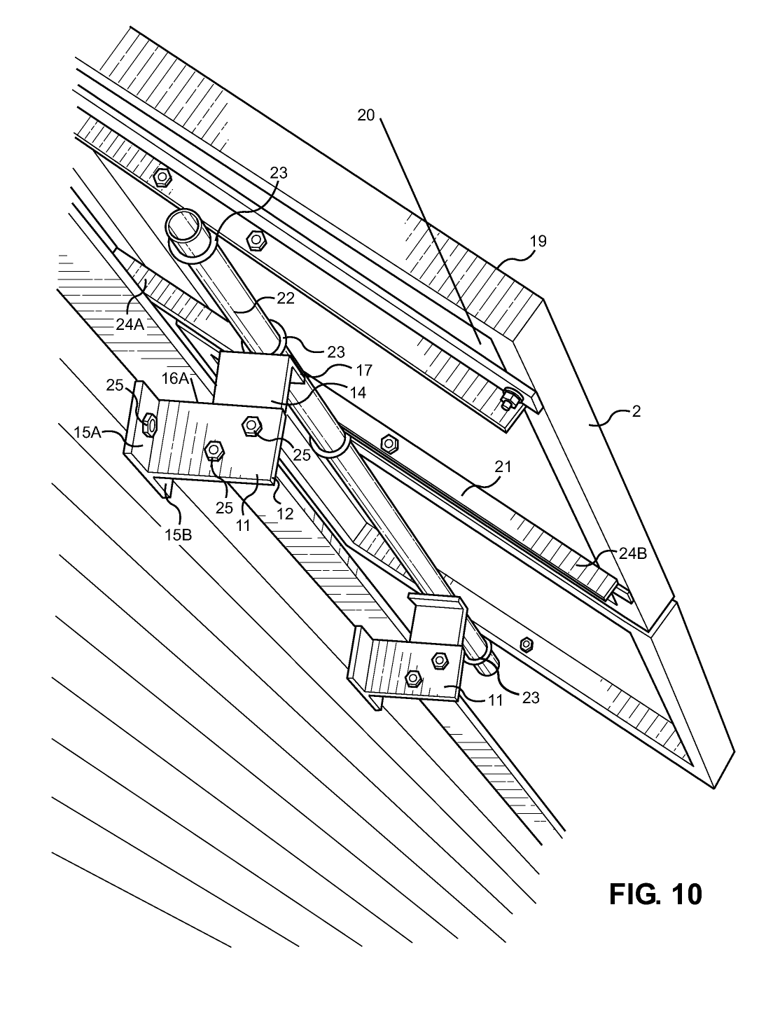

FIGS. 8 and 10 illustrate solar panel 2 having primary side 19 located opposite secondary side 20. Mounting bracket 11 is connected to rod 22. Structure receiving side 15A and 15B (FIG. 10) are connected to a fascia with fastener 25. Mounting bracket 11 has securing side 16A of primary L-bracket 12 that is connected to tertiary L-bracket 14 with fasteners 25. Rod 22 connects solar panel 2 to solar panel receiving side 17 of tertiary L-bracket 14.

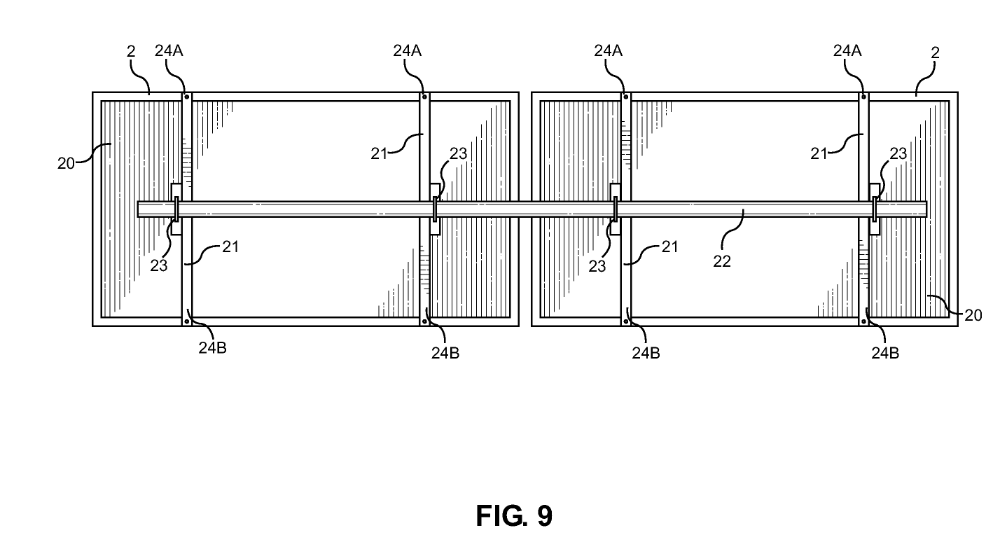

FIGS. 9 and 10 show secondary side 20 of solar panel 2. Support structure 21 has primary end 24A and secondary end 24B connected to secondary side 20 of solar panel 2. Rod 22 is connected to support structure 21 of solar panel 2 with a fastener including, but not limited to, u-bracket 23.

It will thus be seen that the objects set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

Now that the invention has been described,

The invention claimed is:

1. A solar panel having a multipurpose control center configured to generate an electrical current, comprising:
said control center comprising:
an input circuit, said input circuit connecting said solar panel generating an electrical current to a regulating circuit;
said regulating circuit connected to a battery; and,
said battery connected to a thermostatically controlled output circuit, said thermostatically controlled output circuit connected to at least one electrically powered fan, said at least one electrically powered fan is attached to an inner wall, whereby, said wall having an opening, whereby, said electrically powered fan is in communication with an exterior air source through said opening.

2. The solar panel having a multipurpose control center configured to generate an electrical current of claim 1, wherein said battery supplying a backup power supply to at least one household device.

3. The solar panel having a multipurpose control center configured to generate an electrical current of claim 2, wherein said household device being an alarm system.

4. The solar panel having a multipurpose control center configured to generate an electrical current of claim 2, wherein said household device being at least one light emitting unit.

5. The solar panel having a multipurpose control center configured to generate an electrical current of claim 2, wherein said household device being a memory system.

6. The solar panel having a multipurpose control center configured to generate an electrical current of claim 1, wherein said battery supplying a backup power supply to a plurality of electrically powered fans.

7. The solar panel having a multipurpose control center configured to generate an electrical current of claim 1, wherein said at least one electrically powered fan connected to a housing, said housing having an opening configured to receive said at least one electrically powered fan, said housing is configured to be attached to an inner wall of an attic, whereby, said wall having an opening, whereby, said electrically powered fan is in communication with an exterior air source through said opening, said housing having a flange located on an outer perimeter of said housing, whereby, said flange is connected to an attaching element, said attaching element is adapted to connect to a surface of said inner wall of said attic.

8. The solar panel having a multipurpose control center configured to generate an electrical current of claim 7, wherein said flange having at least one opening, whereby, said at least one opening is configured to receive a fastener.

9. The solar panel having a multipurpose control center configured to generate an electrical current of claim 8, wherein said flange having at least one hinged mounting tab.

10. The solar panel having a multipurpose control center configured to generate an electrical current of claim 9, wherein said at least one hinged mounting tab having at least one opening, whereby, said at least one opening configured to receive a fastener.

11. The solar panel having a multipurpose control center configured to generate an electrical current of claim 1, wherein said solar panel is supported by a mounting bracket, said mounting bracket having a first side connected to a structure by at least one fastener, said mounting bracket having a second side supporting said solar panel.

12. The solar panel having a multipurpose control center configured to generate an electrical current of claim 11, wherein said solar panel is pivotally supported by said mounting bracket.

13. The solar panel having a multipurpose control center configured to generate an electrical current of claim 1, wherein said at least one electrically powered fan operates on a variable direct current that is powered by solar power.

14. A solar powered fan housing comprising:
at least one electrically powered fan connected to a housing, said housing having an opening configured to receive said at least one electrically powered fan, said housing is configured to be attached to an inner wall of an attic, whereby, said wall having an opening, whereby, said electrically powered fan is in communication with an exterior air source through said opening; and,
said housing having a flange located on an outer perimeter of said housing, whereby, said flange is connected to an attaching element, said attaching element is adapted to connect to a surface of said inner wall of said attic.

15. The solar powered fan of claim 14, wherein said flange having at least one opening, whereby, said at least one opening is configured to receive a fastener.

16. The solar powered fan of claim 15, wherein said flange having at least one hinged mounting tab.

17. The solar powered fan of claim 14, wherein said flange configured to attach to at least one panel.

18. The solar powered fan of claim 14, wherein said at least one electrically powered fan operates on a variable direct current that is powered by solar power.
